(19) United States
(12) Patent Application Publication
(10) Pub. No.: US 2008/0007811 A1
(43) Pub. Date: Jan. 10, 2008

(54) Scanning apparatus and method

(75) Inventor: Byeung-leul Lee, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/698,079

(22) Filed: Jan. 26, 2007

(30) Foreign Application Priority Data
Jul. 4, 2006 (KR) 10-2006-0062411

(51) Int. Cl. G02B 26/08

(52) U.S. Cl. 359/198; 359/226

(57) ABSTRACT

A scanning apparatus and a scanning method are provided. The scanning apparatus includes: a mirror unit for reflecting an incident light while rotating around a first direction of the scanning apparatus, as well as around a second direction of the scanning apparatus, and a driving unit for driving the mirror unit so that the mirror unit can rotate around the first and the second directions of the scanning apparatus

### CROSS-REFERENCE TO RELATED PATENT APPLICATIONS

This application claims priority from Korean Patent Application No. 10-2006-0062411, filed on Jul. 4, 2006, in the Korean Intellectual Property Office, the disclosure of which is incorporated herein in its entirety by reference.

### BACKGROUND OF THE INVENTION

1. Field of the Invention

Apparatuses and methods consistent with the present invention relate to a scanning apparatus and a scanning method and, more particularly, to a scanning apparatus and method capable of reducing pinch effects.

2. Description of the Related Art

A scanning apparatus scans beams emitted from a light source to a portion of a one-dimensional area (line) or a two-dimensional area (plane) to form images. In addition, the scanning apparatus can be applied to a scanner integrated with an optical sensor such as a photodiode or a photodetector to read information formed on a one-dimensional or two-dimensional region, besides an image forming apparatus.

FIG. 1 is a schematic view of a general scanning type display apparatus. The display apparatus of FIG. 1 includes a laser light source 10 and a scanner 11. The scanner 11 is a two-dimensional scanner. The laser light source 10 generates laser beams according to image signals, and the scanner 11 reflects the laser beams to form scan lines 12 and display an image 13.

In FIG. 1, the scanning line 12 shows a scan trace according to a related art raster scanning method. FIG. 2 illustrates the scan trace of FIG. 1, divided into a horizontal direction and a vertical direction. Referring to FIG. 2, according to the raster scanning method, intervals between each of the scan lines 12 are uniform on a center portion of the image 13; however, intervals between each of the scan lines 12 on left and right sides 21 are not uniform, and thereby generate pinch effects and degrade a vertical resolution.

U.S. Pat. No. 6,140,979 discloses a technique for reducing the pinch effect. However, this technique includes an additional mirror perpendicular to a horizontal rotary axis in the scanner.

### SUMMARY OF THE INVENTION

Exemplary embodiments of the present invention provide a scanning apparatus and method that can reduce pinch effects by controlling a behavior of a mirror included in a scanner to form Lissajours scan patterns in a horizontal direction.

According to an aspect of the present invention, there is provided a scanning apparatus comprising: a mirror unit for reflecting an incident light while rotating around a first direction of the scanning apparatus, as well as around a second direction of the scanning apparatus; and a driving unit for driving the mirror unit so that the mirror unit can rotate around the first and the second directions of the scanning apparatus.

According to another aspect of the present invention, there is provided a scanning method using a scanning apparatus including a mirror unit for reflecting an incident light, the scanning method comprising: generating horizontal scan lines on a screen by applying symmetrical horizontal driving signals to first sides of the mirror unit where the first sides are located centering on a horizontal axis of the mirror unit, and applying asymmetrical horizontal driving signals to second sides of the mirror unit where the second sides are located centering on a vertical axis; and generating vertical scan lines on the screen by applying vertical driving signals to the mirror unit for moving the scanning apparatus in the vertical direction.

### BRIEF DESCRIPTION OF THE DRAWINGS

The above and other features and advantages of the present invention will become more apparent by describing in detail exemplary embodiments thereof with reference to the accompanying drawings, in which:

FIG. 1 is a schematic view of a general scanning type display apparatus;

FIG. 2 illustrates a scanning trace of the apparatus of FIG. 1, divided into horizontal and vertical directions;

FIG. 3 illustrates a structure of a two-dimensional raster scanner to which the present exemplary embodiment is applied;

FIG. 4 illustrates behaviors of the scanner for forming the related art scan pattern of FIG. 2 in directions of the θ axis and the φ axis;

FIG. 5 illustrates a Lissajours pattern scan lines;

FIG. 6 illustrates an expanded view of a mirror unit in FIG. 3;

FIG. 7 illustrates behaviors of the mirror unit of FIG. 3 in the θ direction and the φ′ direction for a horizontal Lisssjours pattern scanning;

FIG. 8 is a plane view of the mirror unit and a driving unit included in the scanning apparatus according to an exemplary embodiment of the present invention;

FIG. 9A is a cross-sectional view of the mirror unit and the driving unit of FIG. 8;

FIG. 9B illustrates voltages applied to the driving unit and a driving comb electrode unit of FIG. 8;

FIG. 10A illustrates V_{H1} voltage;

FIG. 10B illustrates a behavior of the mirror unit in the θ direction according to the voltages V_{H1} and V_{H2};

FIG. 10C illustrates a torque in the θ direction;

FIG. 10D illustrates a torque in the φ′ direction generated by θ, voltages V_{H1} and V_{H2};

FIG. 11 is a plane view of the mirror unit and the driving unit that can control the size of the Lissajours pattern;

FIG. 12 shows a Lissajours pattern whose size is controlled by a magnitude of the torque in the φ′ direction.

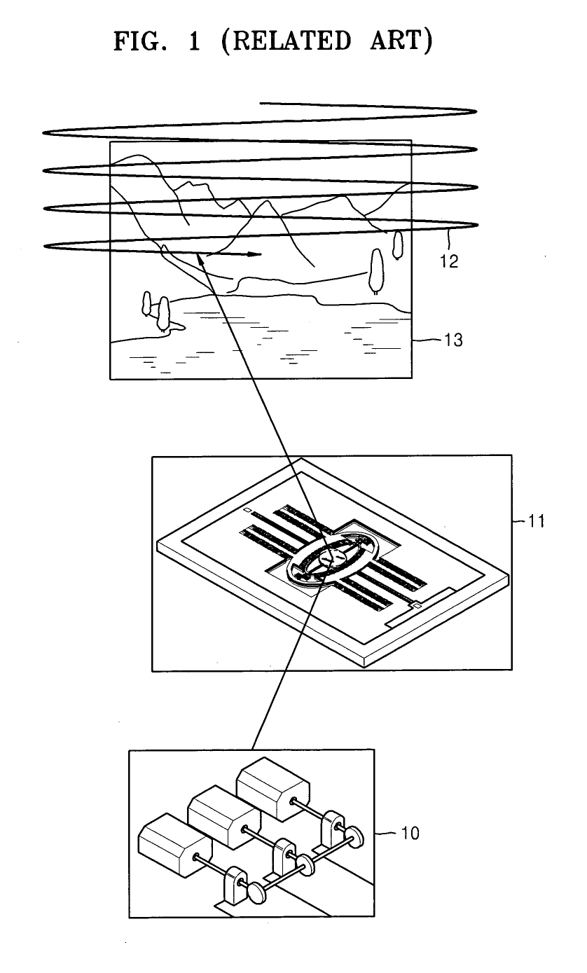

### DETAILED DESCRIPTION OF EXEMPLARY EMBODIMENTS OF THE INVENTION

Hereinafter, a scanning apparatus and method consistent with the present invention will be described with reference to accompanying drawings.

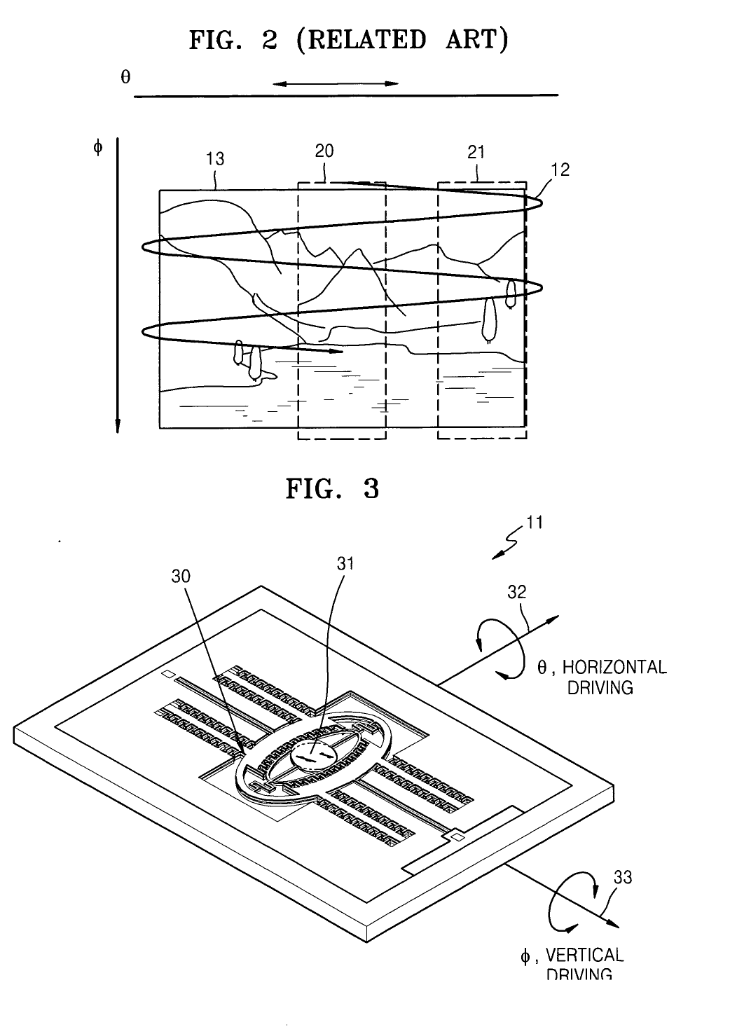

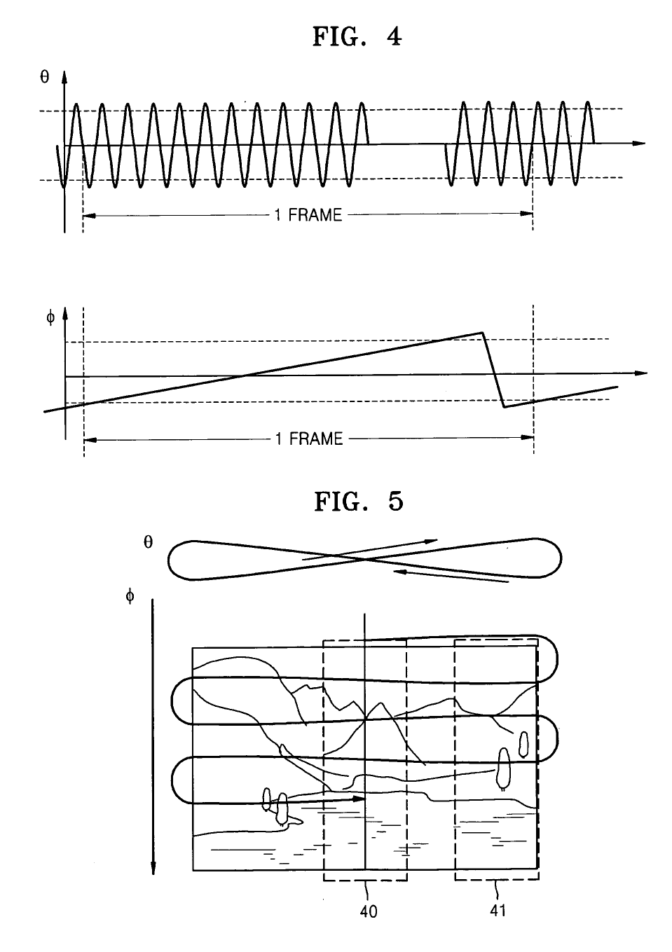

FIG. 3 illustrates a structure of a two-dimensional raster scanner to which the present exemplary embodiment is applied. The scanner 11 includes gimbals 30, and a mirror unit 31 for reflecting laser beams. The scanner 11 forms a scan trace by a horizontal rotation around the θ direction 32 of the mirror unit 31 and a vertical rotation around φ direction 33 of the gimbals 30. FIG. 4 illustrates behaviors of the scanner for forming the related art scan pattern of FIG. 2 in directions of the θ axis and the φ axis. Referring to FIG. 4, it can be seen that the scanner moves linearly in the φ axis direction while rotating around the θ axis within a single frame. The above described raster scanning method causes pinch effects on both sides of the screen as described above.

Accordingly, in order to reduce the pinch effects, the scanner needs to scan in a Lissajours pattern in a horizontal direction of the screen as shown in FIG. 5. Referring to FIG. 5, once the Lissajours pattern scanning is performed in the horizontal direction of the screen, intervals between the scan lines on left/right sides 41 of the screen are as uniform as the intervals between the scan lines on a central portion 40 of the screen, and thus, the pinch effect can be reduced.

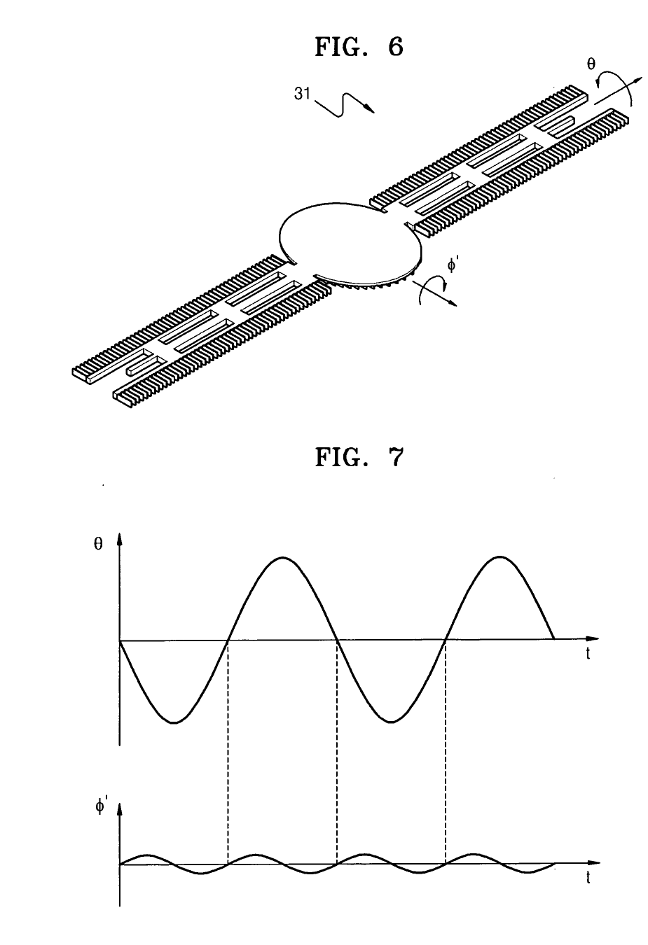

FIG. 6 is an expanded view of the mirror unit 31 of FIG. 3. For the horizontal Lissajours pattern scanning, the mirror unit 31 must rotate around a φ′ direction as well as the θ direction, in addition to the rotation of the gimbals 30 around the φ direction.

FIG. 7 illustrates behaviors of the mirror unit 31 in the θ direction and in the φ′ direction for the horizontal Lissajours pattern scanning. Referring to FIG. 7, the behavior of the mirror unit 31 in the φ′ direction has a frequency twice as that of the behavior in the θ direction, and the phases of the two behaviors are identical.

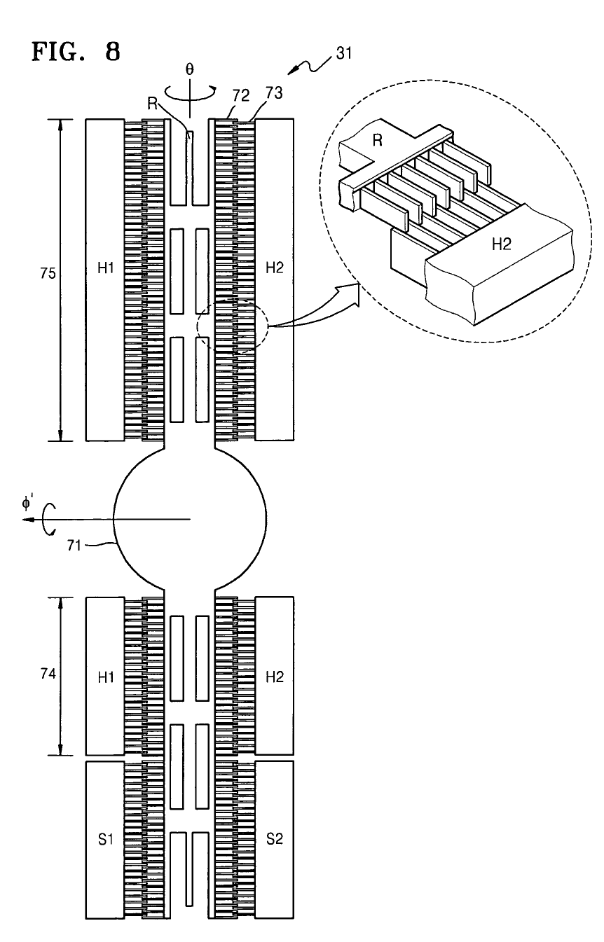

FIG. 8 illustrates the mirror unit 31 and a driving unit included in the scanning apparatus according to the exemplary embodiment of the present invention. The mirror unit 31 includes a mirror 71 and a rotation comb electrode unit R including rotation comb electrodes 72 on both of its blades. The driving units H1 and H2 include driving comb electrodes 73. The rotation comb electrodes 72 and the driving comb electrodes 73 are alternately arranged with each other as shown in the expanded view in FIG. 8.

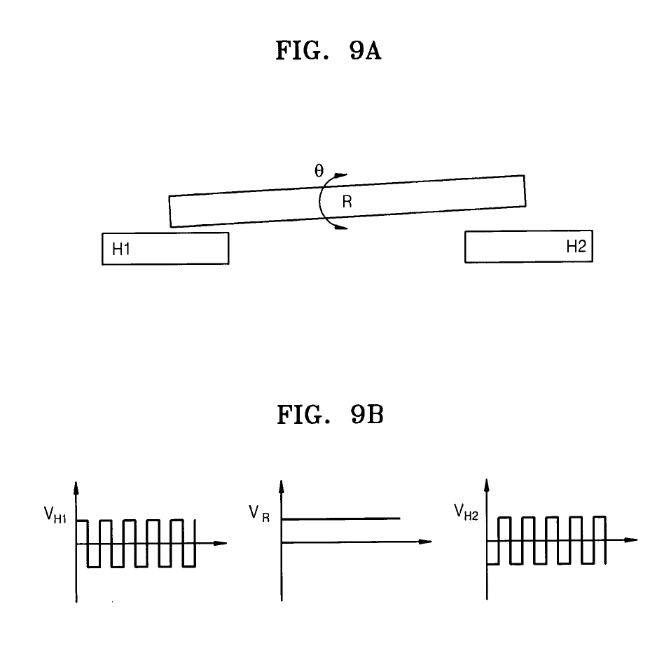

FIG. 9A is a cross-sectional view of the mirror unit 31 and the driving units H1 and H2 of FIG. 8, and FIG. 9B illustrates voltages applied to the driving units H1 and H2 and the rotation comb electrode unit R.

Referring to FIGS. 9A and 9B, when a voltage V_{R} is applied to the rotation comb electrode unit R and voltages V_{H1} and V_{H2} having opposite phases to each other are applied to the driving units H1 and H2 that correspond to opposite sides of the rotation comb electrode unit R, a difference between voltages applied to the driving unit H1 and the rotation comb electrode unit R; that is, V_{R}−V_{H1}, is different from a difference between voltages applied to the driving unit H2 and the rotation comb electrode unit R (V_{R}−V_{H2}), that is, (V_{R}+V_{H1}), and then, the mirror unit 31 is inclined toward one side by an electrostatic force. Then, when voltages having phases that are opposite to the previous ones, respectively, are applied to the driving units H1 and H2, the mirror unit 31 is inclined toward the other side, and thus, the mirror unit 31 rotates around the θ direction.

Referring to FIG. 8 again, a length 74 of H1 or H2, or a whole area of the driving units H1 or H2, located on a lower portion of the mirror unit 31 are different from a length 75 or a whole area of the driving units H1 or H2 located on an upper portion of the mirror unit 31. This difference in length is for the Lissajours pattern scanning. That is, as the length or the area of the upper driving unit H1 or H2 differs from that of the lower driving unit H1 or H2, the torque generated by the same voltage varies, and thus, the mirror unit 31 rotates in the φ′ direction. In this case, the torque is generated in proportion to a square voltage. In FIG. 8, S1 and S2 may be sensor electrodes for sensing horizontal balance.

The area of the upper driving unit H1 or H2 is shown different from that of the lower driving unit H1 or H2 in FIG. 8. In order to obtain the same result as the above-described, the upper and lower driving unit H1 or H2 may have an identical area with a different applied voltage in accordance with another embodiment.

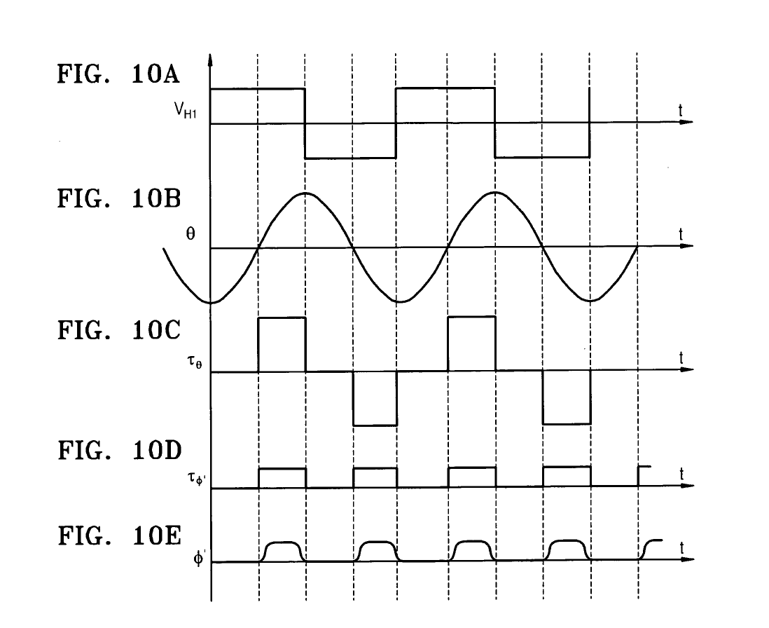

FIG. 10A through 10E illustrate torques and behaviors in each of the θ direction, φ direction, and φ′ direction when the driving voltage V_{H1} is applied to the driving units H1. FIG. 10A shows the voltage V_{H1}, and the voltage V_{H2} is V_{H1} with an opposite phase to the voltage V_{H1}.

FIG. 10B illustrates a behavior of the mirror unit 31 in the θ direction according to the voltages V_{H1} and V_{H2}. FIG. 10C illustrates the torque generated in the θ direction. According to FIG. 10A through 10C, the phase of the torque is determined according to the θ value and the driving voltages V_{H1} and V_{H2}.

FIG. 10D illustrates the torque generated in the φ′ direction by the θ value and the voltages V_{H1} and V_{H2}.

Referring to FIG. 10D, the φ′ direction torque is generated in a frequency twice that of the θ direction torque. Accordingly, the mirror unit 31 rotates around the φ′ direction as shown in FIG. 10E. Therefore, the Lissajours pattern scanning can be achieved by the behavior of the mirror unit 31 in the θ direction and the φ′ direction to reduce the pinch effects.

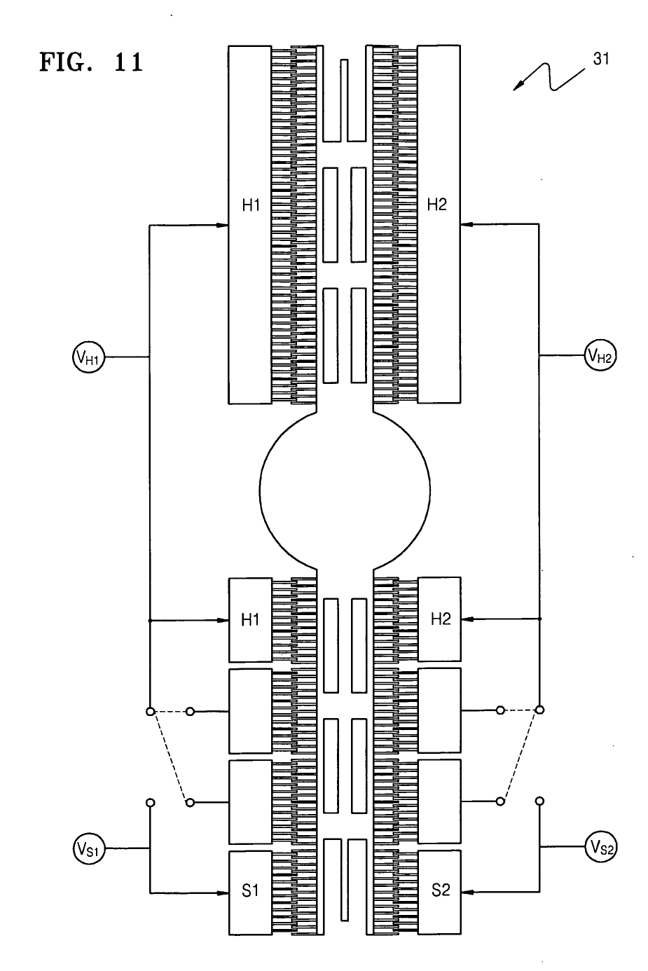

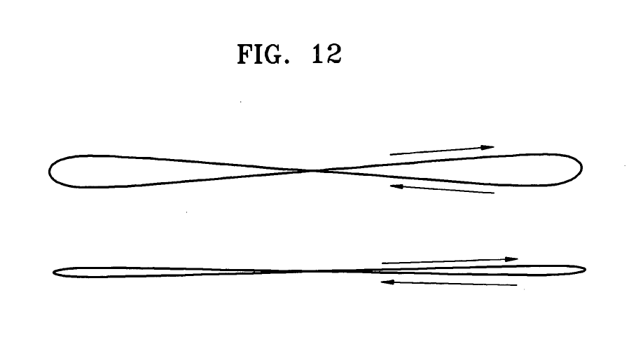

FIG. 11 illustrates the mirror unit 31 and the driving units H1 and H2 that can control the size of the Lissajours pattern. Referring to FIG. 11, the lower driving units H1 and H2 are divided into a plurality of pieces, and the number of pieces, to which the voltages will be applied, is determined to control the magnitude of the torque generated in the φ′ direction. FIG. 12 illustrates the Lissajours pattern, the size of which is controlled according to the magnitude of the torque generated in the φ′ direction.

Consistent with the present invention, the mirror unit of the scanner is driven in the Lissajours pattern, and thus, the pinch effect occurring on the screen can be reduced.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A scanning apparatus comprising:
a mirror unit for reflecting an incident light while rotating around a first direction of the scanning apparatus, as well as around a second direction of the scanning apparatus; and
a driving unit for driving the mirror unit so that the mirror unit can rotate around the first and the second directions of the scanning apparatus.

2. The scanning apparatus of claim 1, wherein the mirror unit comprises:
a mirror for reflecting the incident light; and
first and second rotation comb electrode units, connected to opposite sides of the mirror, including first and second comb electrodes on respective blades.

3. The scanning apparatus of claim 2, wherein the driving unit comprises:
a first driving comb electrode unit including third comb electrodes that are alternately arranged with the first comb electrodes of the first rotation comb electrode unit; and
a second driving comb electrode unit including fourth comb electrodes that are alternately arranged with the second comb electrodes of the second rotation comb electrode unit,
wherein a length of the first driving comb electrode unit is different from a length of the second driving comb electrode unit.

4. The scanning apparatus of claim 3, wherein, in the first driving comb electrode unit, the third comb electrodes are divided into a plurality of pieces and a portion of the pieces required to rotate the mirror unit around the vertical direction is wired and used as a single comb electrode.

5. The scanning apparatus of claim 3, wherein, in the second driving comb electrode unit, the fourth comb electrodes are divided into a plurality of pieces and a portion of the pieces required to rotate the mirror unit around the vertical direction is wired and used as a single comb electrode.

6. The scanning apparatus of claim 3, wherein the first and second driving comb electrode units receive voltages of an identical magnitude.

7. The scanning apparatus of claim 2, wherein the driving unit comprises:
a first driving comb electrode unit including third comb electrodes that are alternately arranged with the first comb electrodes of the first rotation comb electrode unit; and
a second driving comb electrode unit including fourth comb electrodes that are alternately arranged with the second comb electrodes of the second rotation comb electrode unit,
wherein voltages applied to the first and second driving comb electrode units have different magnitudes from each other.

8. The scanning apparatus of claim 1, wherein the first direction is a vertical direction and the second direction is a horizontal direction, and wherein the driving unit drives the mirror unit so that a frequency of the rotation of the mirror unit around the vertical direction is twice a frequency of the rotation of the mirror unit around the horizontal direction.

9. The scanning apparatus of claim 1, wherein the first direction is a vertical direction and the second direction is a horizontal direction, and wherein the driving unit generates a first torque so that the mirror unit can rotate around the horizontal direction, and generates a second torque having a frequency twice a frequency of the first torque so that the mirror unit can rotate around the vertical direction.

10. The scanning apparatus of claim 9, wherein the first torque is generated by applying driving signals having an identical magnitude and opposite phases to first sides of the mirror unit where the first sides are located centering on a horizontal axis of the mirror unit, and the second torque is generated by applying the driving signals to second sides of the mirror unit where the second sides are located centering on a vertical axis and have different areas from each other.

11. A scanning method using a scanning apparatus including a mirror unit reflecting an incident light, the scanning method comprising:
generating horizontal scan lines on a screen by applying symmetrical horizontal driving signals to first sides of the mirror unit where the first sides are located centering on a horizontal axis of the mirror unit, and applying asymmetrical horizontal driving signals to second sides of the mirror unit where the second sides are located centering on a vertical axis; and
generating vertical scan lines on the screen by applying vertical driving signals to the mirror unit for moving the scanning apparatus in the vertical direction.

12. The scanning method of claim 11, further comprising:
controlling a size of the horizontal scan lines by controlling a magnitude of the asymmetric horizontal driving signals.

13. The scanning method of claim 11, wherein the applying of the asymmetric horizontal driving signals is performed by differing areas of electrodes, to which the symmetric horizontal driving signals are applied.
